(19) United States
(12) Patent Application Publication
(10) Pub. No.: US 2004/0001149 A1
(43) Pub. Date: Jan. 1, 2004

(54) Dual-mode surveillance system

(76) Inventor: Steven Winn Smith, Poway, CA (US)

Correspondence Address: Steven W. Smith, Spectrum San Diego, Inc., 15950 Bernardo Center Dr. Ste N., San Diego, CA, 92127, US

(21) Appl. No.: 10/183,619

(22) Filed: Jun. 28, 2002

(51) Int. Cl. H04N 5/225; H04N 7/18

(52) U.S. Cl. 348/218.1; 348/159; 348/207.1; 348/208.13; 348/208.14; 348/340

(57) ABSTRACT

A surveillance system is formed from two video cameras viewing substantially the same region being monitored. One camera provides high temporal resolution, such as a conventional CCTV camera operating at 30 frames per second with 640 pixels per image width. The second camera provides high spatial resolution, such as a linescan sensor with a mechanical scanning assembly, providing 2 images per second with 5120 pixels per image width. The combination of these two cameras provides a video record of the monitored region with simultaneous high spatial resolution and high temporal resolution.

### BACKGROUND OF THE INVENTION

This Invention relates to the acquisition and display of a sequence of images, and particularly to video cameras and recorders used to document criminal activity and other events occurring in a monitored area.

Prior art video surveillance equipment, commonly called Closed Circuit Television (CCTV), acquires and stores a surveillance record in the same format as used in broadcast television. This is an analog signal with a frame rate of 30 images per second, with each image containing 480 lines, and with a bandwidth sufficient to provide approximately 640 resolvable elements per line. For the purposes of comparing analog and digital video signals, it is known in the art that this is comparable to a digital video signal operating with a frame rate of 30 images per second, and with each image containing approximately 640 by 480 pixels. While this prior art format is well matched to the needs of broadcast television, it is inefficient for surveillance use. The goal of surveillance video is to monitor and document the events that occur in an area. To fully achieve this goal, a video surveillance system must be able to record information that allows such tasks as: (1) identifying previously unknown persons by their facial features and body marks, such as tattoos and scars; (2) identifying automobiles by reading their license plates, recognizing their make and model, and recording distinguishing marks such as body damage; and (3) monitoring the actions of person's hands, such as the exchange of illicit drugs and money, the brandishing of weapons, and the manipulation or removal of property.

All these tasks require an acquired image resolution of approximately 80 pixels-per-foot, or greater. That is, the pixel size must be equal to, or smaller than, about 0.15 by 0.15 inches. Prior art systems operating with an effective resolution of 640 by 480 pixels per image can only achieve this minimally acceptable resolution when the field-of-view is set to be 8 by 6 feet, or smaller (i.e., in the horizontal direction: 640 pixels/8 ft.=80 pixels/ft.; in the vertical direction: 480 pixels/6 ft.=80 pixels/ft.). However, this maximum field-of-view for optimal operation is much smaller than typical locations that need to be monitored by surveillance video. For example, the lobby of a building might be 20 to 80 feet across, while a parking lot might be hundreds of feet in size.

Another disadvantage of the prior art is that the video information remains in analog form throughout its use, from acquisition, to storage on magnetic tape, to being displayed on a television monitor. This makes the recorded information susceptible to degradation from long-term storage, stray magnetic fields, and signal-to-noise deterioration from repeated use of the magnetic tape. In addition, analog signals cannot be compressed by removing the correlation been adjacent pixels of the same image, or pixels at the same location in sequential images. This inefficient data representation results in the need for a large storage capacity. Analog video is also limited because it cannot be transmitted over digital communication channels, such as the internet. In addition, only very simple signal processing techniques can be directly applied to analog signals, such as adjustment of the brightness and contrast. Advanced signal processing techniques, such as convolution and Fourier domain manipulation, cannot be used to improve the image quality of prior art systems because of their analog nature. The playback of analog video is likewise limited to only a few simple techniques, such as normal play, fast forward, and reverse. Advanced playback functions such as image zoom (enlargement of a smaller area) are not available, making it difficult for operators reviewing the recorded video to extract the important information.

These problems of the prior art are overcome through the use of a high resolution surveillance camera, as disclosed in U.S. patent application Ser. No. 09/669,692, which is incorporated herein by reference. This approach uses a linescan camera to view a vertical line in the monitored area, in conjunction with a mechanical scanning assembly for repeatedly sweeping the viewed line in the horizontal direction. The resulting video data stream is compressed using MPEG or a similar algorithm, and stored in a large-capacity digital memory. Through the use of an operator interface, images contained in the recorded video can be recalled from memory, uncompressed, and displayed on a video monitor. Also by use of the operator interface, subsections of individual images can be displayed on the video monitor in an enlarged form. This overcomes limitations of the prior art by acquiring video data with a large number of pixels per image, typically 5,120 by 2,048 or greater, and a slow frame rate, typically 2 images per minute.

As thus shown, prior art CCTV systems utilizing broadcast television standards have poor spatial resolution (640×480 pixels per image), but high temporal resolution (30 images per second). This makes them useful for real-time (manned) surveillance, where the high frame rate gives the viewer the impression of smooth motion. However, the low spatial resolution makes prior art CCTV inadequate for recorded (unmanned) surveillance, since it is incapable of capturing faces and other important image features. In contrast, surveillance cameras using the linescan technique have high spatial resolution (5,120×2,048 pixels per image), but low temporal resolution (2 images per second). This makes them excellent for recorded (unmanned) surveillance, but lacking in real-time (manned) applications. What is needed is a video surveillance system that simultaneously provides both high spatial resolution and high temporal resolution.

### BRIEF SUMMARY OF THE INVENTION

The Invention overcomes these limitations through the combination of two video cameras viewing the same monitored area, one camera having a high spatial resolution, and the other camera having a high temporal resolution. The signals from these two cameras are converted into a digital form and compressed to a lower data rate, thereby facilitating digital transmission and storage. Under control of an operator, the video sequences from the two cameras can be displayed either sequentially or simultaneously on a single monitor, either as real-time or recorded video.

It is the goal of the Invention to provide an improved method of electronic video surveillance. Another goal of the Invention is to acquire video data in a spatial and temporal format that is matched to the needs of both manned and unmanned surveillance. It is an additional goal to store and manipulate the surveillance image data in a digital form. A further goal is to provide a spatial image resolution capable of recognizing faces, automobile license plates, actions of the hands, and similar items, while simultaneously monitoring large areas. An additional goal is to provide a temporal image resolution that provides the appearance of smooth motion. Yet an additional goal is to facilitate the use of digital image processing to aid in the extraction of information from the surveillance record.

### BRIEF DESCRIPTION OF THE DRAWINGS

FIG. 1 is a schematic depiction of the Invention.

FIG. 2 is a schematic depiction of one aspect of the Invention.

FIG. 3 is a block diagram depicting the Invention.

FIG. 4 is a block diagram depicting an embodiment of the Invention.

### DETAILED DESCRIPTION OF THE INVENTION

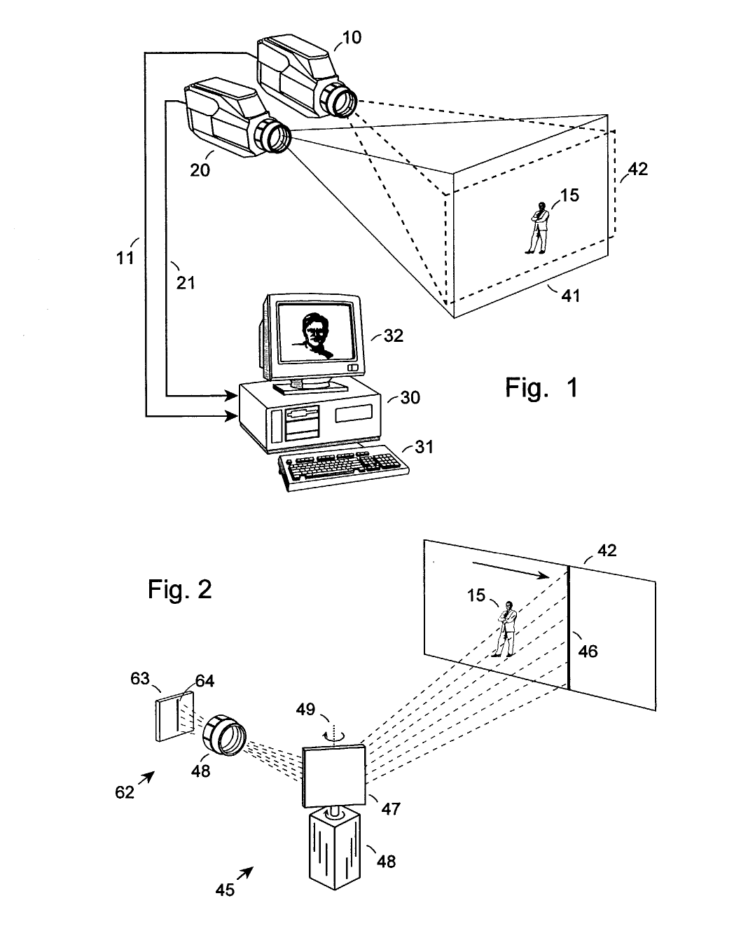

FIG. 1 depicts the operation of the inventive system. A first electronic video camera 20 views a first region 41 being monitored for surveillance purposes. A second electronic video camera 10 views a second region 42 also being monitored for surveillance purposes. While regions 41 and 42 may have slightly different aspect ratios and/or fields of view, they overlap as much as practical, and are substantially of the same physical area. This region of overlap is exemplified in FIG. 1 by the presence of a person 15. The first camera 20 produces a first video signal 21 with a low spatial resolution and a high temporal resolution. In the typical case, this is 30 images per second, with each image having an effective resolution of 640 by 480 pixels. The second camera 10 produces a second video signal 11 with a high spatial resolution and a low temporal resolution. Also in the typical case, this is 2 images per second, with each image having an effective resolution of 5,120 by 2,048 pixels. The two camera signals 11, 21 are routed into computer system 30, where they are converted into a digital form and stored in digital memory. As is know in the art, computer system 30 is a programmable device containing various kinds of digital memory, a video display 32, and operator input devices 31 such as a keyboard and/or mouse. As directed by a system operator using the computer input device 31, the stored video images are recalled from memory 52 and displayed on the monitor 32.

The high temporal resolution camera 20 is of the type widely used in prior art CCTV systems. As know to those skilled in the art, hundreds of models are commercially available from more than a dozen manufacturers. Typical examples are models 1300, 2600, 4810, and 6310 from Cohu Electronics, Poway Calif.; models WVBL730, WVBP550, WVCL830, and WVCP150 from Panasonic, Secaucus N.J.; and models IK528A, IK540A, IK643A, and IK645A from Toshiba America, Irvine Calif. All of these devices produce video signals consisting of 30 images per second with a resolution substantially equal to 640 by 480 pixels per image. Many different electronic configurations exist within this group of cameras and are within the scope of the inventive system. This includes, but is not limited to, black and white images, color images, interline transfer, frame transfer, interlaced output, noninterlaced output, progressive scanning, analog signal output, digital signal output, and other parameters familiar to those skilled in the art of surveillance cameras. Additionally, the camera may include mechanical actuators for the remote control of focusing, aperture, zoom, panning, and related functions.

In one embodiment, the high spatial resolution camera 10 is based around a linescan camera, as disclosed in U.S. patent application Ser. No. 09/669,692, which is incorporated herein by reference. The operation can be understood in part by referring to the schematic depiction in FIG. 2. The high spatial resolution camera 10 is formed from two components, a linescan camera 62, and a mechanical scanner 45. As known in the art, linescan cameras produce an electronic video signal corresponding to the light intensity profile along a single axis, that is, along a single line in space. Linescan cameras are readily available from several commercial sources, for example: models SP-11 and CT-P1 from Dalsa, Inc., Waterloo, Ontario, Canada; models L120-2k and L240 from Basler Vision Technologies, GmbH, Ahrensburg, Germany; and models PL2048SP and PL-5000SF from Pulnex America, Inc., Sunnyvale, Calif. Many different electronic configurations exist within this group of linescan cameras and are within the scope of the present Invention. This includes, but is not limited to, black and white images, color images, various number of sensor elements such as between 1024 to 8192, the use of a time-delay-integrate (TDI) architecture such as between 2 to 256 integration stages, analog signal output, digital signal output, and other parameters familiar to those skilled in the art of linescan cameras.

Light being reflected or otherwise emitted from a narrow vertical line 46 in the monitored region 42 is reflected by mirror 47, captured by the linescan camera lens 48, and focused onto light sensitive region 64 of the linescan image sensor 63. On each line readout, typically lasting between 50 and 500 microseconds, the electronic video signal II is composed of a temporal sequence of analog voltage levels, with each voltage level being proportional to the light detected by one of the 1024 to 8192 sensor elements in the active region 64. In this manner, the viewed line 46 in the monitored region 42 can be converted into an electronic signal 11 in a period of 10 to 500 microseconds, with a resolution of 1024 to 8192 pixels.

The scanner 45 is a mechanism that sweeps the viewed line 46 in the horizontal direction such that the viewed line 46 moves from one side of the monitored region 42 to the other side in a time period of typically 0.1 to 3 seconds. In one embodiment, the scanner 45 consists of a galvanometer rotational servo 48 rotating mirror 47 back-and-forth around a vertical axis 49. Galvanometer servos of this type are well known in the art, and commercial products are manufactured by several companies, for example: model G300 from General Scanning, Inc., Watertown, Mass., or model 6880 from Cambridge Technology, Inc., Cambridge, Mass. In other embodiments, the scanner may consist of a rotating multisided mirror, a flat mirror that oscillated back and forth by means of a mechanical cam, or a back and forth movement of the entire linescan camera.

For typical operation, the monitored area 42 may have a width of 80 feet, and be located at a distance of 60 feet from the mirror 47. To achieve the scanning of viewed line 46 across the monitored region 42, the rotational servo 48 rotates the mirror 47 through a total angle of arctan((w/2)/d), where w is the width of the monitored region and d is the distance to the monitored region. In this typical operation, the total angle of rotation is arctan((80/2)/60)=33.7 degrees. At the completion of the typically 0.5 second image acquisition, rotational servo 48 moves mirror 47 back to its starting position to prepare for the next image. In other words, the high spatial resolution camera 10 generates an analog video signal 11 consisting of a sequence of images of the monitored region 42, at a typical rate of one image each 0.1 to 3 seconds, with each image typically composed of 2048 to 16384 pixels in the horizontal direction, 1024 to 8192 pixels in the vertical direction, and having a typical aspect ratio of 2:1 to 10:1.

In another embodiment, the high spatial resolution camera is a full-frame image acquisition device having a large number of pixels. Imaging sensors and complete cameras are commercially available with pixel counts as large as 4,096×4,096. For instance, model Megapixel by Fovion, Inc., Santa Clara, Calif. has 4,096×4,096 pixels; model KAF16801 by Roper Industries, San Diego, Calif. has 4,096 by 4,096 pixels; and model Dimage 7 by Minolta America, Ramsey N.J., has 2,658 by 1,970 pixels. In this embodiment the optical scanner 45 is not needed, resulting in a slightly simpler mechanical assembly. However, the electrical complexity is greater due to the larger number of pixels in the image sensor, which may result in a lower signal-to-noise ratio in the acquired images.

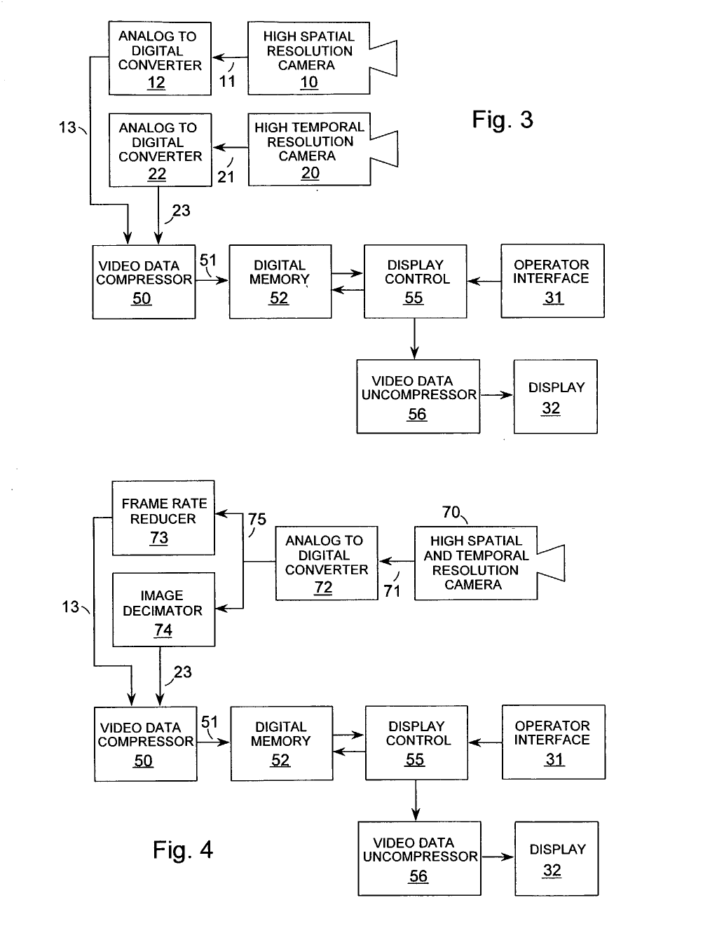

FIG. 3 further depicts the inventive system. As previously described, the high temporal resolution camera 20 produces an analog electronic video signal 21, typically consisting of 30 images per second with an effective resolution of 640 by 480 pixels per image. Likewise, the high spatial resolution camera 10 produces an analog electronic video signal 1, typically consisting of 2 images per second with an effective resolution of 5,120 by 2,048 pixels per image. These two analog video signals 11, 21 are routed into analog to digital converters 12, 22, resulting in digitized video signals 13, 23, respectively. In the preferred case, the analog to digital conversions are synchronous with the element-to-element readout of the image sensors. For example, in the case where the linear array contains 2,048 light sensitive elements, the analog to digital conversion 12 produces a sequence of 2,048 digital numbers per line, with each digital number being determined only by the output of the corresponding line sensitive element. The analog to digital converters can be either built into the cameras 10, 20 or provided as external electronics. Further, the analog to digital converters 12, 22 may be a single device operating in a time multiplexed mode. In this case, the digitized video signals 13, 23 form a multiplexed data stream that can be transmitted, stored, and manipulated by standard digital techniques.

In accordance with the previous discussion, the digital video signal 23 from the high temporal resolution camera 20 has a typical data rate of 30 images/second×640 pixels×480 pixels×1 byte/pixel=9.2 Mbytes/second. Likewise, the digital video signal 13 from the high spatial resolution camera has a typical data rate of 2 images/second×5,120 pixels×2,048 pixels×1 byte/pixel=20.97 Mbytes/second. These digital video signals 13, 23 are converted into a compressed data stream 51 through video data compressor 50. As is known in the art, neighboring pixels within an image are highly correlated. That is, adjacent pixels frequently have a similar or identical value. Many different compression algorithms have been developed to remove the redundant information resulting from this correlation, allowing the digital image to be represented using a fewer number of bytes. Such algorithms include delta encoding, run-length encoding, LZW encoding, Huffman encoding, Discrete Cosine Transform methods, and wavelet compression. In addition to compression of the individual images, it is also possible to compress sequences of images by removing the correlation from image-to-image. In video sequences, including broadcast television and surveillance applications, only a fraction of the scene changes from one image to the next.

This means that each pixel in one image is highly correlated with the corresponding pixels in subsequent images. By removing the redundant information contained in this image-to-image correlation, the video can be compressed far more than by techniques that only remove redundant information within individual images. The compression of digital video by using both within-the-frame compression and between-frame compression is well known in the art. The most common encoding format for this type of video compression is MPEG, which is widely used in consumer products, such as video sequences transmitted over the internet, and the distribution of motion pictures on digital video disks. In addition, integrated circuits are commercially available that directly implement video compression, such as models ADV611 and ADV-JP2000 from Analog Devices, Norwood, Mass. Depending on the amount of activity in the monitored region, video data compression 50 compresses the digital video signals 13, 23 by a factor of 10 to 1000. For typical operation, this results in a data rate of about 1 Mbyte per second in the compressed data stream 51

The compressed digital video signal 51 is continually stored in a large capacity digital memory 52. As known in the art, large capacity digital storage can be accomplished by using many different technologies, including: optical disks, digitally encoded magnetic tape, and solid state memory. It is within the scope of the Invention to use any of these technologies as the digital memory 52. In one preferred embodiment, digital memory 52 is a hard drive with a typical storage capacity of 1 to 500 Gigabytes, or a combination of hard drives with lower capacities. Hard drives capable of this large capacity digital information storage are well known in the art, and routinely used for mass storage in personal computers. As an example of the operation of this preferred embodiment, the compressed data stream 51 has a typical data rate of 1 Mbyte per second and the digital memory 52 has a storage capacity of 100 Gigabytes, resulting in a total recording time of more than one full day (100 Gigabytes/1 Mbytes/second=100,000 seconds=27.8 hours). Increasing or decreasing the storage capacity of the hard drive provides a corresponding increase or decrease in the total recording time. When the digital memory 52 is full, old digital video data is overwritten with new digital video data, thus allowing the inventive system to continually record the most recent events in the monitored area without routine action on the part of a system operator. In another preferred embodiment of the Invention, digital memory 52 consists of a removable digital storage media, such as an optical disk or digitally encoded magnetic tape. In this preferred embodiment, a system operator changes the removable media at periodic intervals, or when the memory is nearly full, thus allowing long term archiving of the surveillance record.

The display control 55 is a digital computer, such as a microprocessor, microcontroller, digital signal processor, or personal computer. In operation, the display control 55 receives commands from the operator via the operator interface 31, allowing the operator to select portions of the surveillance record stored in digital memory 52. These selected portions are routed through video data uncompressor 56 to display 32. Within the scope of the Invention, the operator interface 31 is any device that allows the operator to direct the action of the display control 55, such as a computer keyboard, mouse, joy stick, touch-screen, push-button array, and so on. Also within the scope of the Invention, the display 32 is any device capable of displaying an image to a human, such as a computer video monitor, television, helmet mounted display, direct optical projection onto the operator's retina, and similar devices.

As can be appreciated by those skilled in the art, the high temporal resolution camera and the high spatial resolution camera may share many of the same electronic and mechanical components. In a limited case, for instance, they may have common power supplies or be physically mounted within the same protective enclosure. Further, as previously described, the analog to digital conversion for the two cameras may be carried out by a single device operating in a time multiplexed mode.

Still further, the two cameras may share a common image sensor, analog video signal, and analog to digital conversion, with the signal separation being accomplished digitally. FIG. 4 depicts this embodiment. A single camera 70 produces an analog video signal 71 consisting of a sequence of images with both high temporal resolution and high spatial resolution. For instance, this can be accomplished with one of the previously mentioned 4,096 by 4,096 pixel frame acquisition cameras operating at 30 images per second. After the analog signal 71 is digitized using an analog to digital conversion 72, it has a data rate of 30 images/second×4,096 pixels×4,096 pixels×1 byte/pixel=503.3 Mbytes/second. From this digitized video signal 75 a high spatial resolution digital video signal 13 is extracted by frame reducer 73. The frame reducer operates by discarding the majority of the images in the incoming digitized video signal 75. For instance, in typical operation, the incoming frame rate of 30 images per second is reduced to 2 images per second by discarding 28 images per second. This forms a high spatial resolution, but low temporal resolution, digital video signal 13, having 2 images per second with 4,096 by 4,096 pixels per image. Likewise, a high temporal resolution digital video signal 23 is extracted from the digitized video signal 75 by an image decimator 74. The image decimator operates by discarding the majority of the pixel values in each image. For instance, in typical operation, the incoming image size of 4,096 by 4,096 pixels is reduced to 512 by 512 pixels by subsampling the image by a linear factor of 8; that is discarding 63 of out 64 pixels values. This forms a high temporal resolution, but low spatial resolution, digital video signal 23, having 30 images per second with 512 by 512 pixels per image. As thus described, the Invention simultaneously meets the requirements for both manned and unmanned video surveillance, through the combination of a high temporal resolution digital video apparatus, a high spatial resolution digital video apparatus, digital data compression, digital storage, and the display of selected surveillance video on a monitor. Having thus described the Invention in detail, a description of the preferred embodiment will now be provided.

In a preferred embodiment, the high spatial resolution camera 10 consists of a DALSA model EC-11-02k40 linescan camera, having 2,048 light sensitive elements and 96 TDI stages. An internal analog to digital converter operates synchronously with the pixel readout, providing a grayscale video signal with 8 bit per pixel. The accompanying lens for this linescan camera has a focal length of 50 mm and an f-number of 2.4, such as widely used in 35 mm film-based cameras. This allows a 32 foot high region to be monitored at an approximate distance of 60 feet. Optical deflection mirror 47 is 1.5 inches high and 2 inches wide, and is mounted approximately 2 inches from the camera lens. Rotational servo 48 is one of the previously cited commercial products, preferably with a digitally controlled sweeping speed. By sweeping through an angle of approximately 33.7 degrees in 0.5 seconds, images can be acquired at a rate of 2 images per second, with 5,120 vertical lines per image over an 80 foot wide field of view. These components (linescan camera, lens, mirror, rotational servo) are mounted within a metal case approximately 4″×4″×12″, with a 3″×4″ glass optical window located in front of the mirror. This assembly will hereafter be referred to as the camera head.

The high temporal resolution camera is a conventional color CCTV surveillance camera, physically separated from the camera head, producing an NTSC analog video signal, such as exemplified by the Cohu model 2200. This analog signal is routed into the camera head by means of a BNC connector mounted on the case of the camera head. Within the camera head, the analog signal from the high temporal resolution camera is converted into a digital signal using, for example, an Analog Devices model ADV7195 analog to digital converter integrated circuit. Also within the camera head is the video data compressor, consisting of one or more Analog Devices model ADV-JP2000 video compression integrated circuits. The video data compressor receives the two digitized video signals and generates a compressed data stream that is transmitted from the camera head along a digital communication link, such as a coaxial cable, a twisted pair, or a fiber optic line. As can be appreciated and understood by one skilled in the art, additional support electronics may be needed inside of the camera head to facilitate the operation of these major components. This includes, for instance, a microcontroller to control the flow of digital data, line drivers to pass the digital data from the camera head, and appropriate power supplies.

In operation, the camera head and the conventional CCTV camera are mounted near each other in a location that provides a clear view of the region being monitored. The compressed data stream, containing the video signals from both cameras, is transmitted over the digital communications link to a security monitoring facility, which may be several hundred feet or more away. At this location the inventive system provides for the functions of digital storage, image recall, and image display. In a preferred embodiment these functions are carried out by a personal computer, or a dedicated computer system similar to a personal computer. Here the compressed data stream is received and continually stored on a high capacity harddrive, preferably at least 20-100 Gigabytes. As directed by an operator using the keyboard or mouse, the stored surveillance data is selectively recalled, uncompressed, and displayed on the computer monitor. Uncompression of the data can be carried out either by software running on the personal computer, or dedicated hardware installed within the personal computer, such as based on the Analog Devices ADV-JP2000 chip.

Within the scope of the Invention, the method of storing and displaying the surveillance record takes many preferred forms. In one preferred embodiment, the full data produced by both cameras is stored in the digital memory for latter recall and review. In another preferred embodiment, the complete data from the high spatial resolution camera is stored, but only a fraction of the images produced by the conventional CCTV camera are retained. For instance, only 2 images per second may be stored out of the 30 images per second being generated. While this does not provide a high temporal resolution record, it is more memory efficient and provides low spatial resolution color images to complement the high spatial resolution black and white images. In still another preferred embodiment, only the high spatial resolution video is stored, and the conventional CCTV images are used only for real-time viewing. In yet another preferred embodiment, the video data from both cameras is simultaneously displayed on the monitor for real-time viewing. As can be appreciated by those skilled in the art, many such combinations of storage and display are possible and can be left as user selectable options.

Having thus given the description of the preferred embodiments, it can be appreciated by those skilled in the art that many other modifications are possible for particular applications and are within the scope of the present Invention. Some of these modifications are described as follows.

Within the scope of the Invention, the cameras can be jointly or separately selected or modified to view particular wavelengths or intensities of electromagnetic radiation. For instance, this includes the use of light amplifiers to provide operation in low-light environments and infrared sensitive sensors for operation in total optical darkness. Other modifications within the scope of the Invention include means for the automatic adjustment of the cameras' operating parameters, either jointly or separately. This includes the automatic focusing of the camera lens, based on optimizing the sharpness of the acquired images; automatic adjustment of the camera lens iris, based on the brightness of the acquired images; and automatic gain control of the analog signal before digitization, also based on the brightness of the acquired images. Further modifications within the scope of the Invention employ the use of standard computer devices and software, such as: copying portions of the surveillance record to transportable and/or archive media, such as floppy disks, optical disks, or digital magnetic tape; printing portions of the surveillance record, such as zoom images of faces, on laser or similar printers; and converting portions of the recorded surveillance record to other formats, such as TIFF or GIF images.

Still other modifications within the scope of the Invention include operational features that allow operators to extract information from the video data. An example of this is providing for digital image processing functions that can be applied to individual images or sequences of images, for one or both cameras. Digital image processing functions of this type are well known in the art, including brightness and contrast adjustment, grayscale transforms such as histogram equalization and related adaptive methods, linear and nonlinear filtering, segmentation algorithms, and facial recognition methods.

Although particular embodiments of the Invention have been described in detail for the purpose of illustration, various other modifications may be made without departing from the spirit and scope of the Invention. Accordingly, the Invention is not to be limited except as by the appended claims.

I claim:

1. A dual-mode surveillance system comprising:
a first video camera, said first video camera producing a first video record of a first monitored region, said first video record having a high-temporal resolution;
a second video camera, said second video camera producing a second video record of a second monitored region, said second video record having a high-temporal resolution; said second monitored region being substantially coincident with said first monitored region;

2. A dual-mode surveillance system claimed in claim 1, further comprising:
a first digital memory for storing said first video record;
a second digital memory for storing said second video record;
a video display;
a digital computer, said digital computer transferring said first video record from said first digital memory to said video display, said digital computer transferring said second video record from said second digital memory to said video display,

3. A dual-mode surveillance system claimed in claim 1 wherein said first video record comprises substantially 30 frames per second with each frame having a spatial resolution of substantially 640 pixels by 480 pixels.

4. A dual-mode surveillance system claimed in claim 3 wherein said second video camera comprises a linescan camera viewing a vertical line in said second monitored region, and a scanner for moving said vertical line horizontally across said second monitored region.

5. A dual-mode surveillance system claimed in claim 2 wherein said first video record comprises substantially 30 images per second with each image having a spatial resolution of substantially 640 pixels by 480 pixels.

6. A dual-mode surveillance system claimed in claim 5 wherein said second video camera comprises a linescan camera viewing a vertical line in said second monitored region, and a scanner for moving said vertical line horizontally across said second monitored region.

7. A dual-mode surveillance system claimed in claim 6 wherein said second video record comprises fewer than 3 images per second, with each image having a spatial resolution greater than 2000 pixels by 1000 pixels.

8. A dual-mode surveillance system claimed in claim 5 wherein said second video record comprises fewer than 3 images per second, with each image having a spatial resolution greater than 2000 pixels by 1000 pixels.

9. A method of acquiring surveillance video, comprising:
acquiring a high spatial resolution video record of a monitored region;
acquiring a high temporal resolution video record of said monitored region;
storing said high spatial resolution video record in a digital memory;
storing said high temporal resolution video record in a digital memory;
recalling said high spatial resolution video record from digital memory;
recalling said high temporal resolution video record from digital memory;
displaying said high spatial resolution video record; and
displaying said high temporal resolution video record.

10. The method of acquiring surveillance video claimed in claim 9, further comprising:
acquiring a preliminary video record of said monitored region, said preliminary video record having high spatial resolution and high temporal resolution, wherein said acquiring a high temporal resolution video record comprises decimating said preliminary video record, and wherein said acquiring a high spatial resolution video record comprises discarding images from said preliminary video record.

11. The method of acquiring surveillance video claimed in claim 9, wherein said acquiring a high temporal resolution video record comprises operating a CCTV camera to produce substantially 30 frames per second with substantially 640 pixels by 480 pixels per frame.

12. The method of acquiring surveillance video claimed in claim 11, wherein said acquiring a high spatial resolution video record comprises operating a linescan camera to view a vertical line in said monitored region and scanning said vertical line horizontally across said monitored region.

13. The method of acquiring surveillance video claimed in claim 12, wherein said acquiring a high spatial resolution video record further comprises operating said linescan camera and said scanner to produce a spatial resolution greater than 2000 pixels per image width.

14. A dual-mode surveillance system comprising:
first camera means for acquiring a high temporal resolution video record of a first monitored region;
second camera means for acquiring a high spatial resolution video record of a second monitored region, said second monitored region substantially overlapping said first monitored region;
digital computer means for storing, manipulating, and displaying said high temporal resolution video record and said high spatial resolution video record.

15. The method of acquiring surveillance video claimed in claim 14, wherein said high temporal resolution video record comprises substantially 30 frames per second with 640 pixels by 480 pixels per frame.

16. The method of acquiring surveillance video claimed in claim 14, wherein said second camera means comprises linescan camera means and scanner means.

17. The method of acquiring surveillance video claimed in claim 15, wherein said second camera means comprises linescan camera means and scanner means.

18. The method of acquiring surveillance video claimed in claim 14, wherein said manipulating comprises within-the-frame compression.

19. The method of acquiring surveillance video claimed in claim 14, wherein said manipulating comprises between-frame compression.

20. The method of acquiring surveillance video claimed in claim 14, wherein said digital computer means comprises a first digital computer means for storing, manipulating, and displaying said high temporal resolution video record, and a second digital computer means for storing, manipulating, and displaying said high temporal resolution video record.
